(19) United States
(12) Patent Application Publication
(10) Pub. No.: US 2014/0006136 A1
(43) Pub. Date: Jan. 2, 2014

(54) EXPEDITED REGISTRATION AND PROCESSING OF OFFERS AT A POINT OF TRANSACTION

(71) Applicants: David M. Grigg, Rock Hill, SC (US); Matthew A. Calman, Charlotte, NC (US); Peter John Bertanzetti, Charlotte, NC (US); Alicia C. Jones, Fort Mill, SC (US); Susan Smith Thomas, Gastonia, NC (US)

(72) Inventors: David M. Grigg, Rock Hill, SC (US); Matthew A. Calman, Charlotte, NC (US); Peter John Bertanzetti, Charlotte, NC (US); Alicia C. Jones, Fort Mill, SC (US); Susan Smith Thomas, Gastonia, NC (US)

(73) Assignee: BANK OF AMERICA CORPORATION, Charlottee, NC (US)

(21) Appl. No.: 13/536,730

(22) Filed: Jun. 28, 2012

(51) Int. Cl. G06Q 30/02

(52) U.S. Cl. 705/14.33; 705/14.38

(57) ABSTRACT

Embodiments of the invention include systems, methods, and computer-program products for providing an expedited presentment, registration, processing, and using offers and/or loyalty accounts at a point-of-transaction. The system may determine when a user is initiating a transaction at a point-of-transaction associated with a merchant. After the user has initiated the transaction, he/she may be presented with a detectable indicia at the point-of-transaction. An image of the indicia may be captured or scanned by the user via his/her user device. The captured indicia may provide the user with available offers and/or loyalty account or a communication link to receive available offers and/or loyalty accounts. Upon user selection, the available offers and/or loyalty accounts may be applied to the user's current transaction.

### BACKGROUND

Typically, individuals receive many offers or promotions to entice the individual to shop at a specific merchant. Once the individual is shopping at the merchant he/she may utilize the offers to purchase products. Normally, these offers may be in the form of paper coupons, loyalty cards, and/or the like that an individual may have to present at a point-of-transaction, such as a check out terminal.

However, presenting these offers at a point-of-transaction may be cumbersome and slow the pace of check out for the individual and the individuals in line. Furthermore, many times an individual will forget to present a coupon or loyalty card at the point-of-transaction while the individual is attempting to make a purchase. At a point-of-transaction an individual may be presenting multiple products to a merchant, trying to monitor the running price of the products he/she is purchasing, or the like. Thus, many times a user may forget to use or present offers that he/she may have available to him/her for the products he/she is purchasing.

Therefore, a need exists for a way to provide individuals with available offers, loyalty accounts, or the like at a point-of-transaction, such that the individual may be able to utilize the offers and/or loyalty accounts that are available to him/her without having to provide them manually at the point-of-transaction.

### BRIEF SUMMARY

Embodiments of the present invention address the above needs and/or achieve other advantages by providing apparatuses (e.g., a system, computer program product and/or other devices) and methods for an expedited registration and processing of offers at a point-of-transaction (POT).

Embodiments of the present invention provide for an expedited registration and processing of offers, loyalty accounts, merchant credit cards, and/or the like at a POT. In some embodiments, the user may initiate a transaction at a merchant's POT. Upon initiation of a transaction at a POT, a merchant may provide the user with detectable indicia. The detectable indicia may be presented at the POT at a POT device, such as a register, electronic card reader, merchant scanner, etc. The detectable indicia may include, but is not limited to a bar code, quick response (QR) code, token, contact connection, near field connection, and/or the like. In this way, the detectable indicia may be scanned by the user at the POT and provide the user with the ability to quickly select, register, and process offers and/or loyalty accounts for the current transaction. Therefore, in some embodiments, the detectable indicia may provide the user, via his/her user device with information associated with offers available for the user. In other embodiments, the detectable indicia may provide the user, via his/her user device with information associated with loyalty accounts available for the user.

There may be one or more various indicia that may be provided to a user. In this way, the indicia is provided dynamically to the user. In some embodiments, the indicia may provide information for one or more offers available to the user. In some embodiments, the indicia may provide information for one or more loyalty accounts available to the user. In yet other embodiments, the indicia may provide information for a combination of offers and/or loyalty accounts available to the user.

The offers and/or loyalty accounts available to the user may be determined in several ways. In some embodiments, the available offers and/or loyalty accounts may be dynamically determined based on the products the user is purchasing, the method of payment for completing the transaction, user information determined at the POT, or the like. In this way, the offers and/or loyalty accounts available to the user may be determined from a database of offers and/or loyalty accounts dynamically based on the products the user is purchasing. For example, the scanning of Product 1 at the merchant POT may trigger an offer for Product 1 to be presented to the user via the indicia. However, if the user does not purchase Product 1 at the merchant POT no offer for Product 1 may be presented to the user via the indicia. In this way, the indicia may change dynamically such that specific offers and/or loyalty accounts that are available to that user may be presented to the user. As such, in some embodiments, the system may, prior to presenting the detectable indicia, determine the appropriate offers or loyalty accounts that may be associated with the user.

In some embodiments, the offers and/or loyalty accounts available to a user may be determined after the user scans the indicia. Once the indicia is presented at a POT the user may scan the detectable indicia via his/her user device, such as a mobile phone, Personal Digital Assistant (PDA), or the like.

In some embodiments, once the user scans the indicia offers and/or loyalty accounts that are available to a user may be determined. In this way, the scanning of the detectable indicia may allow for a communication link with a database. The database may comprise user information, offer information, loyalty account information, etc. In some embodiments, the communication may allow the presentment of available offers and/or loyalty accounts to the user. In other embodiments, the user information on the database may be used to fill out and pre-enroll in loyalty accounts.

In some embodiments, upon scanning the detectable indicia the user may receive offers available to him/her. In some embodiments, upon scanning the detectable indicia the user may receive merchant account enrollment. In some embodiments, the offers may be promotions, coupons, discounts, etc. for products that the user is currently purchasing. In other embodiments, the offers may be for products the user may purchase in the future. In this way, in some embodiments, the offers may be targeted to the user based on pre-scanning data, such as products being purchased, user information determined at the POT, method of payment, etc. and/or post-scan data, such as data stored in the database, user device, manually inputted data, etc.

In some embodiments, upon scanning the detectable indicia the user may receive available loyalty account data. The loyalty accounts may include, but are not limited to merchant credit card accounts, merchant loyalty accounts, etc. In this way, in some embodiments, the loyalty accounts may be targeted to the user based on pre-scanning data, such as products being purchased, user information determined at the POT, method of payment, etc. and/or post-scan data, such as data stored in the database, user device, manually inputted data, etc. Data received either pre-scan or post-scan may be used to fill out and/or pre-enroll a user into a loyalty account.

The offers and/or loyalty accounts may be presented to the user via his/her user device. The user may then select to accept offers and/or loyalty accounts for the current transaction or a future transaction. The user may accept the offers by selecting them on his/her user device. The selected offers may then be communicated to the POT and be applied to the transaction.

Embodiments of the invention relate to systems, methods, and computer program products for providing expedited processing at a point-of-transaction comprising: receiving an indication that a user is initiating a transaction at a merchant point-of-transaction; receiving data associated with the initiation of the transaction; matching the data associated with the initiation of the transaction with data stored on a database to determine offers that the user is likely to use, wherein the database comprises available offers associated with the merchant; determining offers available to the user based at least in part on the matching of the data associated with the initiation of the transaction and the data stored on the database; presenting, dynamically, the offers available to the user; receiving indication of user selected offers; and communicating the user selected offers to the merchant such that the offers are applied to the transaction.

In some embodiments, presenting, dynamically, the offers available to the user further comprises providing a detectable indicia at the point-of-transaction wherein the detectable indicia can be captured by the user via a mobile device, wherein the detectable indicia further comprises the offers available to the user. In some embodiments, the detectable indicia changes form based on the offers available to the user.

In some embodiments, the indication that the user is initiating a transaction at a merchant point-of-transaction includes receiving an indication that the user captured a pre-presented indicia.

In some embodiments, the data associated with the initiation of the transaction include one or more of products of the transaction, user identification information, or merchant information associated with the transaction.

In some embodiments, the database further comprises information about the user relating to one or more of user personal data, previously transacted for products, previously transacted for types of products, or previously accepted offers from one or more of the merchant of the transaction or a financial institution associated with the user.

In some embodiments, the offers comprise promotions, discounts, or coupons for the products of the transaction. In some embodiments, the offers comprise loyalty accounts for the merchant of the transaction or a manufacturer of the products of the transaction.

In some embodiments, the information from the database is used to automatically enroll the user in the loyalty accounts selected by the user, such that the loyalty account is applied to the transaction.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a point-of-transaction offer processing method for providing expedited registration and processing of offers at a point-of-transaction, in accordance with one embodiment of the present invention;

FIG. 2 provides a point-of-transaction offer processing system environment, in accordance with one embodiment of the present invention;

FIG. 3 provides a process map illustrating dynamic offer presentment and acceptance at a point-of-transaction, in accordance with one embodiment of the present invention;

FIG. 4 provides a process map illustrating database offer presentment and acceptance at a point-of-transaction, in accordance with one embodiment of the present invention;

FIG. 5 provides a process map illustrating dynamic loyalty account presentment and acceptance at a point-of-transaction, in accordance with one embodiment of the present invention;

FIG. 6 provides a process map illustrating database loyalty account presentment and acceptance at a point-of-transaction;

FIG. 7 provides a decision map illustrating steps of a user selecting and using offers and/or loyalty accounts at a point-of-transaction, in accordance with one embodiment of the present invention; and

FIG. 8 illustrates user interfaces for the selecting and using offers and/or loyalty accounts at a point-of-transaction, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. A “merchant” as used herein may refer to a manufacturer, retailer, service provider, event provider, warehouse, supplier, and/or the like. Furthermore, as used herein, the term “product” shall mean any good, service, event, etc. that may be offered by a merchant. An “offer” as used herein may refer to any promotions, coupons, discounts, advertisements, deals, etc. that a merchant, manufacturer, or other entity may be providing. A “loyalty account” as used herein may refer to any merchant credit card accounts, gift card, frequent visitor card, club card, promotional card, merchant loyalty account, etc. that may be available to a user from a merchant, manufacturer, or other entity.

Further, the embodiments described herein may refer to use of a transaction or transaction event to trigger the point-of-transaction (POT) offer processing program. Unless specifically limited by the context, a “transaction” refers to any communication between the user and a merchant, financial institution, or other entity. For example, in some embodiments, a transaction may include one or more of the following: purchasing, renting, leasing, bartering, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a POT system is operated in a public place (e.g., on a street corner, at the doorstep of a private residence, in an open market, at a public rest stop, etc.). In other embodiments, the POT system, is additionally or alternatively operated in a place of business (e.g., in a retail store, post office, banking center, grocery store, factory floor, etc.). In accordance with some embodiments, the POT system is not owned by the user of the POT system. Rather, in some embodiments, the POT system is owned by a mobile business operator or a POT operator (e.g., merchant, vendor, salesperson, etc.). In yet other embodiments, the POT system is owned by the financial institution offering the POT system providing functionality in accordance with embodiments of the invention described herein.

Some portions of this disclosure are written in terms of a financial institution providing the POT offer processing program. It is understood that the invention is meant to provide some form of an offer and/or loyalty account presentment, acceptance, and processing for use by users at a POT. The provider of the POT offer processing program should not be limited to a financial institution, but instead include any institution that may be in a position to provide such a program to users at a POT.

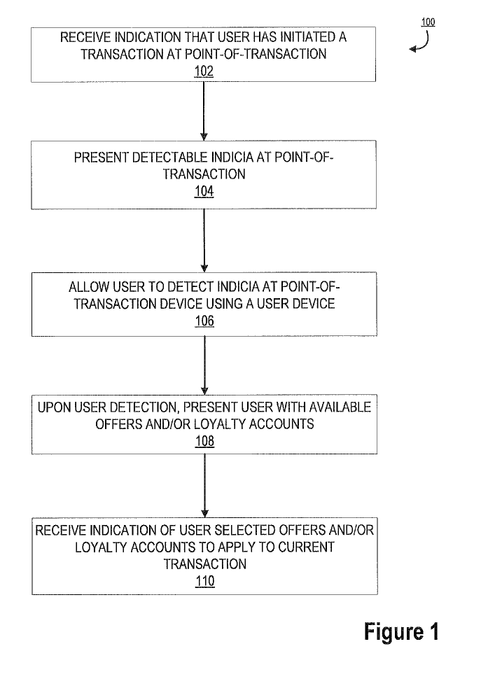

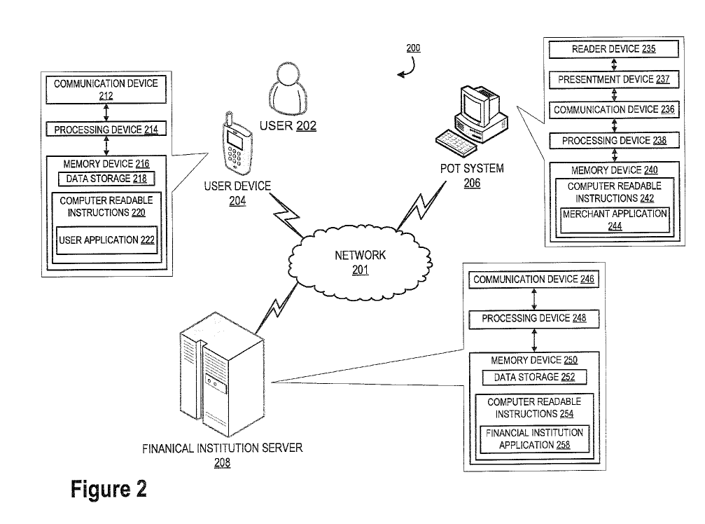

FIG. 1 provides a high level process flow illustrating a point-of-transaction offer processing method for providing expedited registration and processing of offers at a point-of-transaction 100, which will be discussed in further detail throughout this specification with respect to FIGS. 2 through 8. The first step in the process 100, as illustrated in block 102 is receiving an indication that a user has initiated a transaction at a POT. The indication may be any kind of notice that the user has initiated the purchase of a product at any type of POT, whether via a check-out kiosk, at a merchant POT, online shopping cart, other electronic check-out systems, and/or the like. Once the system recognizes that a user is initiating a transaction at a POT the system may present a detectable indicia at the POT, as illustrated in block 104. The detectable indicia may be detectable by a user via his/her user device. As such, the indicia may include, but is not limited to bar code, quick response (QR) code, scanning communication, picture recognition, number recognition, contact connection, near field connection, and/or the like.

In some embodiments, the indicia may include offers for the user. In some embodiments, the offers may be promotions, coupons, discounts, etc. for products that the user is currently purchasing. In other embodiments, the offers may be for products the user may purchase in the future.

In some embodiments, the indicia may include loyalty accounts for the user. In some embodiments, loyalty accounts may include, but are not limited to merchant credit card accounts, merchant loyalty accounts, etc.

The offers and/or loyalty accounts may be targeted to the specific transacting user based on data received prior to the use scanning the indicia, or pre-scanning data, such as products being purchased, user information determined at the POT, method of payment, etc. In this way, the presented indicia may dynamically change to include offers and/or loyalty accounts based on pre-scanning data. As such, when the user scans the detectable indicia, the user may be presented with offers and/or loyalty accounts that are tailored to him/her.

In some embodiments, the indicia may provide for a communication link between the user device and the POT offer processing system. In this way, the offers and/or loyalty accounts presented to the user may be based on post scan-data, such as data stored in the database, financial institution data, user device, manually inputted data, etc. In this way, the indicia may not necessarily be presented dynamically, but instead may initiate a communication link, such that the user may receive offers and/or loyalty accounts available to him/her and/or offers and/or loyalty accounts that the use may actually utilize during a transaction.

Next, as illustrated in block 106, the user is allowed to detect the indicia at the POT. This detection may be done using a camera, scanner, or other recognition medium on a user device. In some embodiments, the user may decide not to detect the indicia at the POT, as such the user may proceed to complete his/her transaction without the offers and/or loyalty accounts available to him/her using the POT offer processing system.

As illustrated in block 108, after the user has recognized the indicia and detected it with his/her user device, the user may be presented with offers and/or loyalty accounts data on his/her user device. The offers may be for products the user is currently transaction for or may be transacting for in the future. The loyalty account data may include loyalty accounts that the user is already enrolled in, such that he/she may use that loyalty account for the transaction. The loyalty account data may also include loyalty accounts that the merchant has available to the user that he/she has not yet enrolled in. In this way, the POT offer processing system may pre-enroll the user into the loyalty account, such that upon user acceptance the new loyalty account may be used for the current user transaction. In this way, the user does not have to fill out an application, or provide any other information in order to enroll in the loyalty program. Instead the POT offer processing system may provide the merchant with all requisite data and instantly enroll the user into the loyalty account program.

Finally, the user may select one or more offers and/or loyalty accounts available to him/her to be applied to the current user transaction. As such, as illustrated in block 110, the system may receive an indication of the user selected offers and/or loyalty accounts and apply the selected offers and/or loyalty accounts to the current user transaction.

FIG. 2 provides a POT offer processing system environment 200, in accordance with one embodiment of the present invention. As illustrated in FIG. 2, the financial institution server 208 is operatively coupled, via a network 201 to the user device 204, and to the POT system 206. In this way, the financial institution server 208 can send information to and receive information from the user device 204 and the POT system 206 to provide an expedited presentment, registration, and processing of offers and/or loyalty accounts for a user to use at a POT. FIG. 2 illustrates only one example of an embodiment of a POT offer processing system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual making a transaction, such as a financial transaction. The transaction may be made at a POT system 206 of a merchant, online or offline, at the merchant's place of business and/or other transaction means. The purchase may be made by the user 202 using any type of payment means available to the user 202, such as, but not limited to cash, credit cards, debit cards, gift cards, checks, etc. Furthermore, the user 202 may use his/her user device 204, such as a mobile device, mobile wallet (e.g. smart phone, PDA, etc.) or other types of payment system that may communicate with POT system 206 to allow the user 202 to complete a transaction. Furthermore, in some embodiments, the user 202 may be a merchant or a person, employee, agent, independent contractor, etc. acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the POT system 206 and the user device 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the financial institution application 258 including but not limited to data created and/or used by the financial institution application 258.

In the embodiment illustrated in FIG. 2 and described throughout much of this specification, the financial institution application 258 allows for the expedited receiving, determining, processing, and applying offers and/or loyalty accounts that are available to the user 202 at a POT. As such, the financial institution application 258 may receive indications that a user 202 is at a POT system 206, determine offers and/or loyalty accounts available to the user 202, determine the detectable indicia that is presented to the user 202, recognize user 202 selected offers and/or loyalty accounts, provide required data for selected offers and/or loyalty accounts, and transmit selected offers and/or loyalty accounts to POT system 206 for implementation at transaction. Furthermore, the financial institution application 258 allows for a communication link between the user device 204 and the POT system 206 to provide the POT offer processing program.

In some embodiments, the financial institution application 258 may receive indications that a user 202 is at a POT system 206. The user 202 may be checking out at a merchant, online shopping, manual checkouts, and/or any other type of POT. The indication that a user 202 is at a POT system 206 may be communicated by the POT system 206 and/or the user device 204. The indication may be that a user 202 is scanning products at a POT system 206, global positioning system (GPS) recognition that a user 202 is located near a POT, near-field communication, etc. In some embodiments, the financial institution application 258 may receive an indication that the user 202 is at a POT system 206 prior to providing a detectable indicia to the POT system 206. In this way, the financial institution application 258 may determine offers and/or loyalty accounts that are available to the user 202, such that the available offers and/or loyalty accounts maybe presented to the user 202 via the detectable indicia presented to the user 202 at the POT system 206. In other embodiments, the financial institution application 258 may receive an indication that the user 202 is at a POT system 206 by receiving a notification that the user 202 scanned an indicia. In this way, the user 202 may scan a standard indicia at the POT that communicably links the systems of the POT offer processing system. In this way, the financial institution application 258 may determine from a database, available offers and/or loyalty accounts for the user 202. The financial institution application 258 may then communicate these offers and/or loyalty accounts to the user 202 such that they are presented to the user 202 via his/her user device 204.

In some embodiments, the financial institution application 258 may determine offers and/or loyalty accounts available to the user 202. Offers and/or loyalty accounts that a merchant may offer to one or more users may be stored in a database accessible by the financial institution application 258. The database may be accessible by the financial institution application 258 in order to provide the user 202 with offers and/or loyalty accounts that are available to the user 202. As such, the database may be stored in the data storage 252 of the financial institution server 208. In this way, the financial institution application 258 may determine which offers and/or loyalty accounts on the database may be available to the user 202 and be able to present those to the user 202. The financial institution application 258 may search all offers and/or loyalty accounts on the database and pull available offers and/or loyalty accounts for each user 202. The availability of offers and/or loyalty accounts for a user 202 may be determined by the merchant the user 202 is transacting with, the products the user 202 is purchasing, the proficiency of purchasing of the user 202 at the merchant, etc. In some embodiments, the available offers and/or loyalty accounts may be determined based on pre-scan data. In some embodiments, the available offers and/or loyalty accounts may be determined based on post-scan data. The data may be utilized to match offers and/or loyalty accounts that are on the database to the data such that the user 202 may be presented with offers and/or loyalty accounts that are available to him/her as well as offers and/or loyalty accounts that the user 202 may be interested in using for a transaction.

Pre-scan data is data that may be determined about a user 202 prior to the user 202 scanning the indicia at the POT system 206. Pre-scan data may include, but is not limited to the products being purchased by the user 202, user 202 information determined at the POT system 206, method of payment, information from the method of payment (e.g. credit card information, loyalty account information, etc.), etc. Post-scan data is data that may be determined about the user 202 after the user 202 has scanned the indicial at the POT system 206. Post scan-data may include, but is not limited to data stored in the database, user device 204, manually inputted from a user 202, etc.

In some embodiments, once the offers and/or loyalty accounts that are available to the user 202 are determined, the financial institution application 258 may present them to the user 202. In some embodiments, the offers and/or loyalty accounts may be presented to the user 202 via a detectable indicia at the POT system 206. In some embodiments, the offers and/or loyalty accounts may be presented to the user 202 via his/her user device 204.

In some embodiments, the financial institution application 258 may present the available offers and/or loyalty accounts to the user 202 via a detectable indicia at the POT system 206. In this way, prior to presenting an indicia at the POT system 206 the financial institution application 258 may determine pre-scan data associated with the user 202. The pre-scan data may be matched with data on the database to determine one or more offers and/or loyalty accounts that are available to the user 202. The financial institution application 258 may collect the available offers and/or loyalty accounts and provide them to the POT system 206 in the form of a detectable indicia. The detectable indicia may comprise the available offers and/or loyalty accounts, such that upon user 202 scanning the detectable indicia, the user 202 may view the available offers and/or loyalty accounts on his/her user device 204.

In some embodiments, the offers and/or loyalty accounts may be presented to the user 202 via his/her user device 204. In this way, the user 202 may have already scanned an indicia at the POT system 206. The financial institution application 258 may determine from post-scan data one or more offers and/or loyalty accounts that are available to the user 202. Upon scanning the indicia, in this embodiment, the financial institution application 258 may determine from information associated with the user device 204, the financial institution, and/or the database offers and/or loyalty accounts that are available to the user 202. The financial institution application 258 may then communicate the available offers and/or loyalty accounts to the user 202 via his/her user device 204.

In some embodiments, the financial institution application 258 may, after user 202 selection of offers and/or loyalty accounts he/she may wish to use, recognize the selected offers and/or loyalty accounts. The offers and/or loyalty accounts may be selected by the user 202 using his/her user device 204. The selected offers and/or loyalty accounts may be communicated from the user device 204 to the financial institution application 258 via a network 201.

Upon receipt of the accepted offers and/or loyalty accounts the financial institution application 258 may determine if more data is required to allow the user 202 to utilize the selection. For example, in some embodiments, the user 202 may select to enroll in a loyalty account offered by a merchant. Typically, the user 202 may be required to provide information such as his/her address, telephone number, social security number, etc. in order to enroll in the loyalty account. However, the financial institution application 258, because of the data accessible by the financial institution application 258, such as that stored on the database, user device 204, manually inputted by a user 202, at the financial institution, and the like, may be able to provide this information for enrollment into the loyalty account without user 202 input. As such, the financial institution application 258 may determine the data that is required to allow the user 202 to utilize his/her selected offers and/or loyalty accounts and provide that data to the necessary merchant.

The financial institution application 258 may then transmit the additional data as well as the user 202 selected offers and/or loyalty accounts to the POT system 206. The POT system 206 may then be able to apply the user 202 selected offers and/or loyalty accounts to the transaction the user 202 is entering into at the POT system 206.

Finally, the financial institution application 258 may allow for a communication link between the user device 204, the POT system 206, and the financial institution server 208 to provide the POT offer processing program. In this way, upon user 202 scanning of the indicia the financial institution application 258 may communicably link the user device 204, the POT system 206, and the financial institution server 208 in order to send and receive data associated with the POT offer processing program, in order to facilitate the utilization of offers and/or loyalty accounts at a POT.

As illustrated in FIG. 2, the POT system 206 generally comprises a reading device 235, a presentment device 237, a communication device 236, a processing device 238, and a memory device 240. The reading device 235 is operatively coupled to the processing device 238, communication device 236, and the memory device 240. The POT system 206 may include a reader device 235 to receive payment account information from the user 202 through the user device 204, financial institution server 208, and/or other potential user 202 payment devices. Such a reader device 235 may include, but is not limited to a magnetic strip reader, a barcode scanner, a radio frequency (RF) reader, a character recognition device, a magnetic ink reader, an NFC reading device, a processor for interpreting codes presented over an electrical or optical medium, a biometric reader, a wireless receiving device, and/or the like. In some embodiments, the reading device 235 receives information that may be used to determine pre-scan data such as data from the user's payment account, and/or the like. The pre-scan data may then be communicated via the communication device 236 over a network 201, to other systems such as, but not limited to the financial institution server 208 and/or the user device 204. As such, the communication device 236 generally comprises a modem, server, or other device for communicating with other devices on the network 201.

The POT system 206 may also comprise a presentment device 237. A person of ordinary skill in the art will appreciate that the presentment device 237 may be a standalone device, may be incorporated into the POT system 206 (such as in the reader device 235), and/or the like. The presentment device 237 may include a screen presentment, reflection presentment, augmented image presentment, touchless communication, touch communication, or other medium that may be viewable and/or scannable.

As further illustrated in FIG. 2, the POT system 206 comprises computer-readable instructions 242 stored in the memory device 240, which in one embodiment includes the computer-readable instructions 242 of a merchant application 244. A POT system 206 may refer to any device that may be configured to carry out a transaction.

In some embodiments, a POT system 206 is or includes an interactive computer terminal that is configured to initiate, perform, complete, and/or facilitate one or more transactions. A POT system 206 could be or include any means that a user 202 may use to perform a transaction with an merchant, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a POT system 206 is operated in a public place (e.g., on a street corner, at the doorstep of a private residence, in an open market, at a public rest stop, etc.). In other embodiments, the POT system 206 is additionally or alternatively operated in a place of business (e.g., in a retail store, post office, banking center, grocery store, factory floor, etc.). In accordance with some embodiments, the POT system 206 is not owned by the user of the POT system 206. Rather, in some embodiments, the POT system 206 is owned by a mobile business operator or a POT operator (e.g., merchant, vendor, salesperson, etc.). In yet other embodiments, the POT system 206 is owned by a financial institution offering the POT system 206 providing functionality in accordance with embodiments of the invention described herein.

The POT system 206 as discussed herein may include any point-of-transaction device, such as a cash register, ATM, smart phone, back end server of a merchant, etc. As such, the POT system 206 may be able perform a sale, an account balance check, a reward transfer, and account money transfer, a user 202 opening up a bank application on his mobile device or computer, a user 202 using his/her e-wallet, and/or the like.

In the embodiment illustrated in FIG. 2, the merchant application 244 allows the POT system 206 to be communicably linked to the financial institution server 208 and other devices on the network 201 to communicate, via a network 201, an indication that the user 202 is at a POT system 206, present indicia, provide information related to the transaction being made, such as the transaction type, cost of transaction, product type, merchant location, user 202 location, etc., receive selected offers and/or loyalty accounts, and/or apply the selected offers and/or loyalty accounts to the transaction.

In some embodiments, the merchant application 224 may provide the other devices in the POT offer processing system 200 with an indication that the user 202 is at a POT and initiating a transaction with a merchant. The indication that a user 202 is at a POT system 206 may be communicated when the user 202 approaches the POT, when a product is initially scanned at a POT, when the user 202 scans the indicia, and/or when the user 202 provides a payment method for purchase of the products of the transaction.

In some embodiments, the merchant application 244 may present indicia to the user 202. In some embodiments, the indicia may be presented initially to indicate that a user 202 is initiating a transaction at a POT. In this way, a communication link is formed between the systems such that the user 202 may be sent offers and/or loyalty accounts from the financial institution server 208 to his/her user device 204. In some embodiments, the indicia may be dynamically presented based on pre-scan data that is determined about the user 202. The detectable indicia may be sent to the merchant application 244 from the financial institution server 208 for the user 202 to scan from the presentment device 237. The detectable indicia may, in some embodiments, provide, within the indicia, offers and/or loyalty accounts available to the user 202. As such, upon scanning the detectable indicia the user 202 may be presented with offers and/or loyalty accounts that are available to him/her at his/her user device 204.

In some embodiments, the merchant application 244 may communicate pre-scan data and/or post-scan data such as information related to the transaction being made, which may include, but is not limited to the products the user 202 is purchasing, the type of products the user 202 is purchasing, the brand of products the user 202 is purchasing, user 202 location, type of transaction, the merchant the user 202 is purchasing from, the user 202 payment device, such as a credit card, debit card, cash, check, line-of-credit, etc.

In some embodiments, the merchant application 244 may also receive selected offers and/or loyalty accounts. The selected offers and/or loyalty accounts may be received after a user 202 scans the indicia and selects offers and/or loyalty accounts available to him/her. The selected offers and/or loyalty accounts may be reviewed by the merchant application 244 to determine which of the selected offers and/or loyalty accounts may be applied to the user's current transaction with the merchant. In some embodiments, the selected offers and/or loyalty accounts that may be able to be applied to the user's current transaction may be applied to the transaction, such that the user 202 may receive the benefit of the offers and/or loyalty accounts for the current transaction. For example, a user 202 may select an offer for Product 1 and also be purchasing Product 1. In this way, the merchant application 244 may apply the offer to the user's current transaction for Product 1. In some embodiments, the merchant application 244 may recognize that some of the selected offers and/or loyalty accounts may not be applied to the current transaction. In this way, the merchant application 244 may provide the unused selected offers and/or loyalty accounts to the database, such that when it is determined that the user 202 is at a POT in the future, the user 202 may be able to utilize the unused selected offers and/or loyalty accounts for that transaction. As such, the unused selected offers and/or loyalty accounts may be presented again to the user 202 via a detectable indicia during a future transaction at a POT. For example, the user 202 may select an offer for Product 2. However, the merchant application 244 may not identify Product 2 as being a part of the user's current transaction. As such, the merchant application 244 may communicate the offer for Product 2 to the database, such that when it is recognized that the user 202 is transacting at a POT for Product 2 in the future, the offer for Product 2 may be utilized during that transaction.

FIG. 2 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the POT system 206 and the financial institution server 208. As such, the communication device 212 generally comprises a modem, server, or other device for communicating with other devices on the network 201.

As further illustrated in FIG. 2, the user device 204 comprises computer-readable instructions 220 stored in the memory device 216, which in one embodiment includes the computer-readable instructions 220 of a user application 222. In this way, the user application 222 allows a user 202 to scan the indicia, decode the indicia, present offers and/or loyalty accounts, and communicate selected offers to the POT system 206. A “user device” 204 may be any mobile communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 2, the POT offer processing system environment 200 may contain numerous user devices 204.

In some embodiments, the user application 222 allows a user 202 to scan and/or recognize an indicia at a POT. The user 202 may scan the indicia using the camera functionality, scanning functionality, etc. of his/her user device 204. The user application 222 may then recognize the indicia and/or the offers and/or loyalty accounts associated thereon. Upon recognition of the indicia the user application 222 may, in some embodiments, present the user 202 with offers and/or loyalty accounts available to the user 202 via an interface associated with the user device 204. In other embodiments, upon recognition of the indicia the user application 222 may communicate with the financial institution server 208 to transmit user 202 data and receive available offers and/or loyalty accounts to present to the user 202.

In some embodiments, the user application 222 may decode the indicia that was scanned. In some embodiments, the user application 222 may decode the indicia that includes offers and/or loyalty accounts available to the user 202. In this way, upon decoding the indicia, the user application 222 may present the offers and/or loyalty accounts to the user 202 via an interface associated with the user device 204. In other embodiments, the user application 222 may decode the indicia to find instructions to communicate with the financial institution server 208. In this way, upon decoding the indicia, the user device 204 may communicate with the financial institution server 208. The financial institution server 208 may then communicate the available offers and/or loyalty accounts to the user 202 via an interface associated with the user device 204.

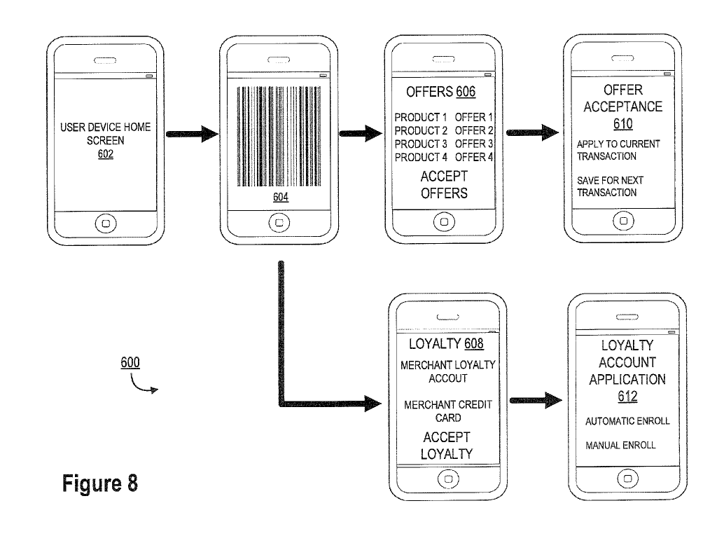

Once the indicia is decoded, the user application 222 may present the offers and/or loyalty accounts to the user 202. Whether the offers and/or loyalty accounts are decoded from the indicia or communicated from the financial institution server 208, the user application 222 may present the offers and/or loyalty accounts to the user 202 via an interface via a viewable screen or the like associated with the user device 204. In this way, the user 202 may be able to visualize the available offers and/or loyalty accounts, as further illustrated in FIG. 8. The user 202 may then be able to select the offers and/or loyalty accounts that a user 202 may wish to use for his/her current transaction or future transactions.

Finally, the user application 222 may communicate the user 202 selected offers and/or loyalty accounts. The selected offers and/or loyalty accounts may be communicated to the financial institution server 208 and/or the POT system 206 via the network 201. The selected offers and/or loyalty accounts may then be applied to the transaction the user 202 is currently entering into and/or future transactions.

It is understood that the servers, systems, and devices described herein illustrate one embodiment of the invention. It is further understood that one or more of the servers, systems, and devices can be combined in other embodiments and still function in the same or similar way as the embodiments described herein.

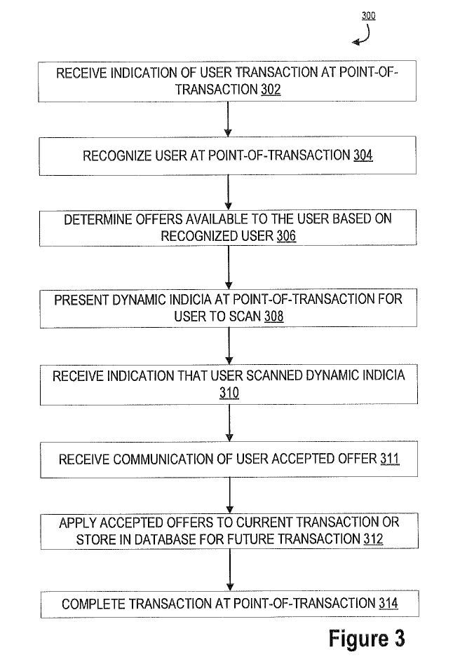

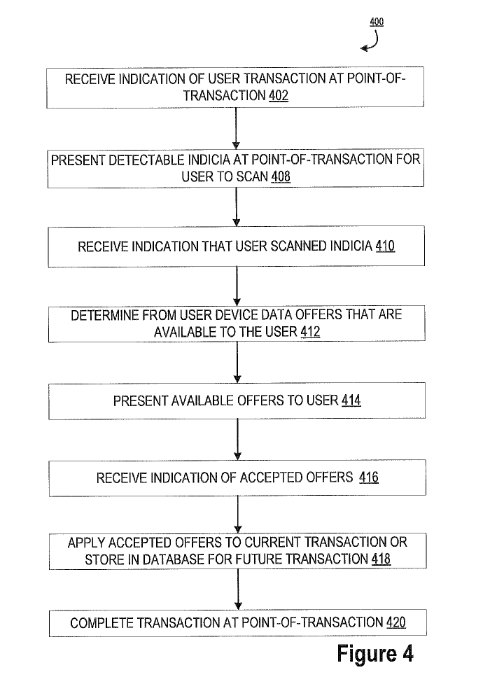

FIG. 3 and FIG. 4 illustrate various embodiments of offer presentment and acceptance at a POT. FIG. 3 illustrates a process map of dynamic offer presentment and acceptance of a POT 300, in accordance with one embodiment of the present invention. As illustrated in block 302 of FIG. 3 the system may receive an indication of a user initiating a transaction at a POT. The initiating of a transaction may include, but is not limited to a user 202 approaching a merchant POT and allowing a merchant to scan products, the user 202 inputting products into an online shopping card for later purchase, and/or the like.

Upon receiving the indication of the user 202 is initiating a transaction, the system may, as illustrated in block 304, recognize the user 202 at the POT. A recognition of the user 202 may be done at the POT by the scanning of a loyalty card, the scanning of payment account, scanning of products for a transaction, information from the merchant at the POT, and/or any other means in which information about a user 202 may be determined by a POT. In this way, the system may determine pre-scan (pre-scanning of the indicia) data associated with the user 202 and the products the user 202 is purchasing. The pre-scan data may provide data such as user personal information, such as name, address, telephone number, etc., user 202 demographic, user 202 geographic location, the products the user 202 is purchasing, the type of products the user 202 is purchasing, and/or the like. In this way, the system may be able to determine specific information about the user 202 or a stereotype of the user 202 such that the system may be able to match offers to that user 202.

As illustrated in block 306, once the user 202 is recognized at the POT, the system may determine offers that are available to that user 202. The offers may be determined based on the pre-scan data of the user recognition in block 304. The pre-scan data may then be used to match the user 202 with offers that are stored on the database. The database may comprise all offers available for use through the program. The offers may be received from, but not limited to, merchants, vendors, manufacturers, financial institutions, other users, entities, retailers, etc. The database may be organized in such a way that the offers that are provided to each user 202 are tailored to that user 202. For example, a merchant and/or financial institution may determine that a user 202 always purchases a particular brand of cereal. As such, the system may match that user 202 with all offers associated with that brand. Furthermore, offers may be matched for products that the user 202 is currently transacting for, as determined by pre-scan data.

In some embodiments, loyalty accounts, frequency of shopping at a particular merchant, etc. may be used to determine the offers that the user 202 may receive. In some embodiments, the database may store multiple offers for one product. The user 202 may receive a better offer if he/she matches rules criteria set by the merchant providing the offer. For example, the merchant may provide the database with an offer for 50% off any one product for first time customers. The database may, through pre-scan data, determine that the user 202 is a first time customer at that merchant, and provide the user 202 with the 50% off offer. However, if pre-scan data determines that the user 202 has shopped at that merchant several times in the past, the system will not present the user 202 with the 50% off offer. In this way, offer providers may be able to set rules for which users may receive the offers that the offer provider is providing.

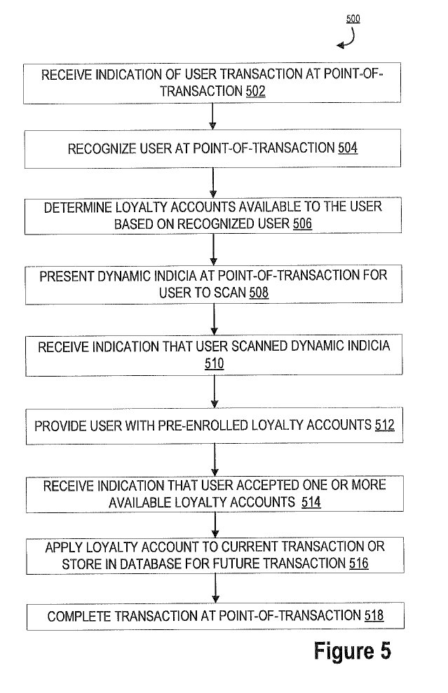

Once the system has determined the offers available to the user 202, the system may communicate them to the POT. In some embodiments, the system may determine offers available to the user 202. In some embodiments, as further illustrated below in FIG. 5, the system may determine loyalty accounts available to the user 202. In this way, the communication of offers may include one or more offers, one or more loyalty accounts, and/or a combination thereof. In some embodiments, the offers may be communicated to the POT in a detectable indicia form. In other embodiments, the offers may be communicated in another form to the POT for the POT system 206 to convert the offers into a detectable indicia form. Once the offers are communicated, the detectable indicia in a dynamic form, including the offers may be presented to the user 202 at a POT, as illustrated in block 308. In this way, the offers may be directed to products, merchants, etc. that the user 202 may be purchasing during his/her transaction with the merchant or in a future transaction.

As illustrated in block 310, the system may receive an indication that the user 202 has scanned the detectable indicia. The scanning may be done via a scanning functionality, photo taking functionality, or any other image recognition functionality associated with the user device 204. The indication may be a communication from the user device 204 and/or the POT system 206.

At this point, the user 202 may accept the offers or decline the offers. If the user 202 declines the offers, then no further processing by the system may be needed. The system may, however, retain the declined offer in the database associated with that user 202. In this way, the database may provide for an artificial intelligent learning of the user 202 and/or the offers he/she accepts/denies. The system may then be able to push offers to the user 202 based on the user's offer acceptance history.

If the user 202 accepts the offer, the system may receive communication of the accepted offer, as illustrated in block 311. The system may then determine to apply the accepted offers to the current transaction or store the accepted offers in a database for use during a future transaction, as illustrated in block 312. In this way, the system may determine where to direct the offer. In some embodiments, the system may store the accepted offer in the database for the user 202 to use during a later transaction. In some embodiments, the system may communicate the accepted offer to a POT for user 202 use during his/her current transaction.

As illustrated in block 312, the offers that are determined to be useable for the current transaction may be applied to the current transaction. As such, the system may provide the offers to the POT system 206, for the POT system 206 to process the offers with the user's transaction. The offers that are determined to be stored for future transactions may be delivered and stored in the database associated with the user 202. This way, these offers may be presented to the user 202 and/or POT the next time the user 202 is transacting for a product or with a merchant that may accept the offer.

Finally, as illustrated in block 314, the transaction may be completed between the user 202 and the merchant at a POT. The transaction may include the offers that were accepted by the user 202. In this way, the offers may be utilized in real-time to transactions the user 202 is entering into. As such, the invention may allow for more expedited use of offers and/or loyalty cards for a transaction.

FIG. 4 illustrates a process map of a database offer presentment and acceptance at a POT 400, in accordance with one embodiment of the present invention. As illustrated in block 402 of FIG. 4, similar to above in FIG. 3, the system may receive an indication of a user initiating a transaction at a POT. The initiating of a transaction may include, but is not limited to a user 202 approaching a merchant POT and allowing a merchant to scan products, the user 202 inputting products into an online shopping card for later purchase, and/or the like.

Upon receiving the indication of the user 202 is initiating a transaction, the user 202 may be presented with an indicia for the user 202 to scan, as illustrated in block 408. This indicia may be generic and may not be dynamic contain offers that are specifically tailored to the user 202. This indicia, on the other hand, may authorize and provide a communication link between the user device 204 and the other devices on the system.

As illustrated in block 410, the system may receive an indication that the user 202 scanned the indicia and as such, is now communicably linked with the user device 204. Using this communication, the system may determine offers that are available to the user 202, as illustrated in block 412. In some embodiments, the offers available to the user 202 may be determined from information received from the user device 204. In this way, the system may receive information, such as the user's name, phone number, address, etc. from information stored on the user device 204. The system may then compare that data to financial institution data to determine transaction history of the user 202, payment types most used by the user 202, etc. That data may then be utilized to match the user 202 with available offers for him/her on the database, as illustrated in block 412.

As illustrated in block 414, once the system has determined offers that are available to the user 202, the system may commutate the offers to the user 202 directly through the communication link established with the user device 204. The user 202 may be presented with the offers such that he/she may visualize the offers available to him/her through an interface, such as the one illustrated in FIG. 8.

At this point, the user 202 may accept or decline offers available to him/her. If the user 202 declines the offers, then no further processing by the system may be needed. The system may, however, retain the declined offer in the database associated with that user 202. In this way, the database may provide for an artificial intelligent learning of the user 202 and/or the offers he/she accepts/denies. The system may then be able to push offers to the user 202 based on the user's offer acceptance history.

If the user 202 accepts the offer, the system may receive communication indicating the accepted offer, as illustrated in block 416. The system may then determine to apply the accepted offers to the current transaction or store the accepted offers in a database for use during a future transaction, as illustrated in block 418. In this way, the system may determine where to direct the offer. In some embodiments, the system may store the accepted offer in the database for the user 202 to use during a later transaction. In some embodiments, the system may communicate the accepted offer to a POT for user 202 use during his/her current transaction.

As illustrated in block 418, the offers that are determined to be useable for the current transaction may be applied to the current transaction. As such, the system may provide the offers to the POT system 206, for the POT system 206 to process the offers with the user's transaction. The offers that are determined to be stored for future transactions may be delivered and stored in the database associated with the user 202. This way, these offers may be presented to the user 202 and/or POT the next time the user 202 is transacting for a product or with a merchant that may accept the offer.

Finally, as illustrated in block 420, the transaction may be completed between the user 202 and the merchant at a POT. The transaction may include the offers that were accepted by the user 202. In this way, the offers may be utilized in real-time to transactions the user 202 is entering into. As such, the invention may allow for more expedited use of offers and/or loyalty cards for a transaction.

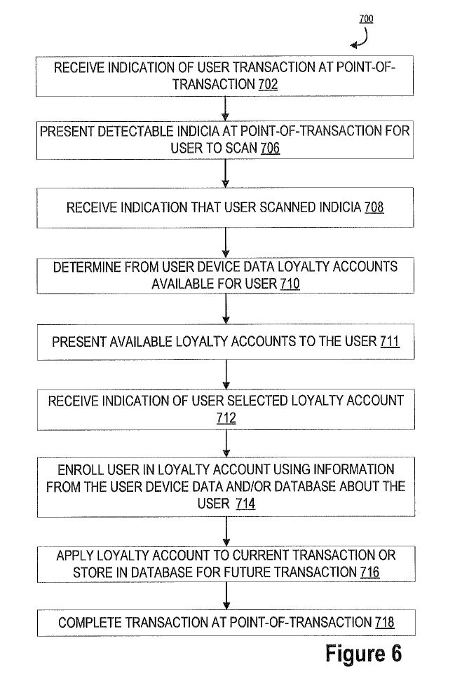

FIG. 5 and FIG. 6 illustrate various embodiments of loyalty account presentment and acceptance at a POT. FIG. 5 illustrates a process map of dynamic loyalty account presentment and acceptance of a POT 500, in accordance with one embodiment of the present invention. Loyalty accounts may include, but are not limited to any merchant credit card accounts, gift card, frequent visitor card, club card, promotional card, merchant loyalty account, etc. that may be available to a user from a merchant, manufacturer, or other entity.

As illustrated in block 502 of FIG. 5, similar to above with respect to FIG. 3, the system may receive an indication of a user initiating a transaction at a POT. The initiating of a transaction may include, but is not limited to a user 202 approaching a merchant POT and allowing a merchant to scan products, the user 202 inputting products into an online shopping card for later purchase, and/or the like.

Upon receiving the indication of the user 202 is initiating a transaction, the system may, as illustrated in block 504, recognize the user 202 at the POT. A recognition of the user 202 may be done at the POT by the scanning of a loyalty card, the scanning of payment account, scanning of products for a transaction, information from the merchant at the POT, and/or any other means in which information about a user 202 may be determined by a POT. In this way, the system may determine pre-scan (pre-scanning of the indicia) data associated with the user 202 and the products the user 202 is purchasing.

As illustrated in block 506, once the user 202 is recognized at the POT, the system may determine loyalty accounts that are available to that user 202. The loyalty accounts available may be determined based on the merchant the user 202 is transacting with, the products the user 202 is purchasing, the user's currently loyalty accounts, etc. For example, a user 202 may be transacting with Merchant A. This data may then be used to match the user 202 with loyalty accounts that are stored on the database. The database may comprise all loyalty accounts available for use through the program. The loyalty accounts may be received from, but not limited to, merchants, vendors, manufacturers, financial institutions, other users, entities, retailers, etc. The database may be organized in such a way that the loyalty accounts that are provided to each user 202 are tailored to that user 202.

Once the system has determined the loyalty accounts available to the user 202, the system may communicate them to the POT. The communication of loyalty accounts available to the user 202 may include one or more offers, one or more loyalty accounts, and/or a combination thereof. In some embodiments, the loyalty accounts available to the user 202 may be communicated to the POT in a detectable indicia form. In other embodiments, the loyalty accounts may be communicated in another form to the POT for the POT system 206 to convert the loyalty accounts into a detectable indicia form. Once the loyalty accounts are communicated, the detectable indicia including the loyalty accounts may be presented to the user 202 at a POT, as illustrated in block 508. In this way, the loyalty accounts may be directed to products, merchants, etc. that the user 202 may be purchasing during his/her transaction with the merchant or in a future transaction.

As illustrated in block 510, the system may receive an indication that the user 202 has scanned the dynamically presented detectable indicia. The scanning may be done via a scanning functionality, photo taking functionality, or any other image recognition functionality associated with the user device 204. The indication may be a communication from the user device 204 and/or the POT system 206.

At this point, the user 202 is provided with pre-enrolled loyalty accounts that are available to the user 202, as illustrated in block 512. The user 202 may accept the available loyalty accounts or decline them. If the user 202 declines the loyalty accounts, then no further processing by the system may be needed. The system may, however, retain the declined loyalty account information in the database associated with that user 202. In this way, the database may provide for an artificial intelligent learning of the user 202 and/or the loyalty accounts he/she accepts/denies. The system may then be able to push loyalty accounts to the user 202 based on the user's prior loyalty account acceptance and enrollment history.

If the user 202 accepts the loyalty account, the system may receive communication of the accepted loyalty account, as illustrated in block 514. The user 202 may accept one or more loyalty accounts that were provided to the user 202. The system may then determine the information required to enroll the user 202 into the loyalty account. As such, the system may then communicate with a financial institution, the database, the user device 204, and/or other devices to receive the information required for user 202 enrollment. Once the system has received the information required for enrollment, the system may automatically enroll the user 202 into the loyalty account. As such, the system may communicate with the merchant, manufacturer, etc. that is providing the loyalty account in order to automatically, in real-time or close thereto, enroll the user 202 into the loyalty account.

As illustrated in block 516, the accepted loyalty accounts that the system has now automatically enrolled the user 202 in, may be applied to the current transaction. As such, the system may provide the user's newly enrolled loyalty account information to the POT system 206 for the POT system 206 to apply the loyalty account to the user's transaction. In some embodiments, the accepted loyalty accounts that the system has now enrolled the user 202 in may not be used for the current transaction. As such, the loyalty accounts may be stored in the database for future transactions. Furthermore, the user 202 may later receive information related to the enrolled loyalty accounts via email, mail, text message, etc.

Finally, as illustrated in block 518, the transaction may be completed between the user 202 and the merchant at a POT. The transaction may include the loyalty accounts that the user 202 accepted. In this way, the accepted loyalty accounts may be utilized in real-time to transactions the user 202 is entering into. As such, the invention may allow for more expedited use of offers and/or loyalty cards for a transaction.

FIG. 6 illustrates a process map of a database loyalty account presentment and acceptance at a POT 700, in accordance with one embodiment of the present invention. As illustrated in block 702 of FIG. 6, similar to above in FIG. 5, the system may receive an indication of a user 202 initiating a transaction at a POT. The initiating of a transaction may include, but is not limited to a user 202 approaching a merchant POT and allowing a merchant to scan products, the user 202 inputting products into an online shopping card for later purchase, and/or the like.

Upon receiving the indication of the user 202 is initiating a transaction, the user 202 may be presented with an indicia for the user 202 to scan, as illustrated in block 706. This indicia may be generic and may not be dynamic contain loyalty accounts that are specifically tailored to the user 202, like described above in FIG. 5. This indicia, on the other hand, may authorize and provide a communication link between the user device 204 and the other devices on the system.

As illustrated in block 708, the system may receive an indication that the user 202 scanned the indicia and as such, is communicably linked with the user device 204. Using this communication, the system may determine loyalty accounts that are available to the user 202, as illustrated in block 710. In some embodiments, the loyalty accounts available to the user 202 may be determined from information received from the user device 204. In this way, the system may receive information, such as the user's name, phone number, address, etc. from information stored on the user device 204. The system may then compare that data to financial institution data to determine transaction history of the user 202, payment types most used by the user 202, currently enrolled loyalty accounts, etc. That data may then be utilized to match the user 202 with available loyalty accounts for him/her on the database, as illustrated in block 710.

As illustrated in block 711, once the system has determined the loyalty accounts that are available to the user 202, the system may commutate the loyalty accounts to the user 202 directly through the communication link established with the user device 204. The user 202 may be presented with the loyalty accounts such that he/she may visualize the loyalty accounts available to him/her through an interface, such as the one illustrated in FIG. 8.

At this point, the user 202 may accept or decline the loyalty accounts that are available to him/her. If the user 202 declines the loyalty account, then no further processing by the system may be needed. The system may, however, retain the declined loyalty account in the database associated with that user 202. In this way, the database may provide for an artificial intelligent learning of the user 202 and/or the loyalty accounts that he/she accepts/denies.

If the user 202 accepts the loyalty account, the system may receive communication indicating the accepted loyalty account, as illustrated in block 712. The user 202 may accept one or more loyalty accounts that were provided to the user 202. The system may then determine the information required to enroll the user 202 into the loyalty account. As such, the system may then communicate with a financial institution, the database, the user device 204, and/or other devices to receive the information required for user 202 enrollment. Once the system has received the information required for enrollment, the system may automatically enroll the user 202 into the loyalty account, as illustrated in block 714. As such, the system may communicate with the merchant, manufacturer, etc. that is providing the loyalty account in order to automatically, in real-time or close thereto, enroll the user 202 into the loyalty account.

As illustrated in block 716, the accepted loyalty accounts that the system has now automatically enrolled the user 202 in, may then be applied to the current transaction. As such, the system may provide the user's newly enrolled loyalty account information to the POT system 206 for the POT system 206 to apply the loyalty account to the user's transaction. In some embodiments, the accepted loyalty accounts that the system has now enrolled the user 202 in may not be used for the current transaction. As such, the loyalty accounts may be stored in the database for future transactions. Furthermore, the user 202 may later receive information related to the enrolled loyalty accounts via email, mail, text message, etc.

Finally, as illustrated in block 718, the transaction may be completed between the user 202 and the merchant at a POT. The transaction may include the loyalty accounts that the user 202 accepted. In this way, the accepted loyalty accounts may be utilized in real-time to transactions the user 202 is entering into. As such, the invention may allow for more expedited use of offers and/or loyalty cards for a transaction.

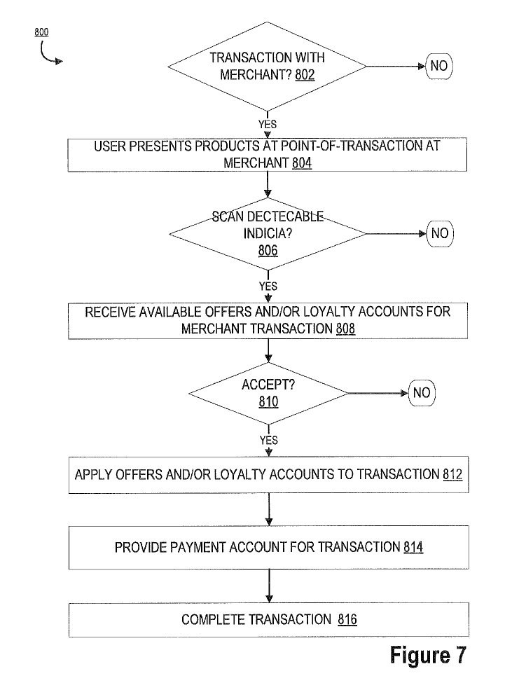

FIG. 7 illustrates a decision map of the steps a user takes in selecting and using offers and/or loyalty accounts at a point-of-transaction 800, in accordance with one embodiment of the present invention. As illustrated in decision block 802, the user 202 may decide to transact with a merchant. The transaction may be at a merchant place of business, online, etc. If the user 202 decides not to transact with the merchant, the process is terminated. If the user 202 decides to transact with the merchant in decision block 802, the user 202 may present the products he/she wishes to purchase to a POT associated with the merchant, as illustrated in block 804.

Once the user 202 is at a POT and has initiated a transaction with the merchant, the user 202 may be presented with an indicia. As such, in decision block 806, the user 202 may decide whether to scan the indicia or not. If the user 202 does not scan the indicia, then the process is again terminated. If the user 202 does scan the indicia, using his/her user device 204, the user 202 may receive available offers and/or loyalty accounts for the transaction with the merchant, as illustrated in block 808.

FIG. 8 illustrates user interfaces for the selecting and using offers and/or loyalty accounts at a point-of-transaction 600, in accordance with one embodiment of the present invention. The user 202 may use his/her user device 204 to scan the indicia. As such, in block 602 the user 202 may power on his/her user device 204. Next the user 202 may capture the indicia, in this case a bar code, using capturing functionality of the user device, as illustrated in block 604. Once the indicia is captured, the user 202 may be displayed offers 606, loyalty accounts 608, and/or a combination thereof.

Referring back to FIG. 7, as illustrated in decision block 810, the user 202 may decide to accept the offers and/or loyalty accounts provided to him/her. If the user 202 does not accept the offers and/or loyalty accounts the process is terminated at that point. If the user 202 does accept the offers any/or loyalty accounts, the system may apply the offers and/or loyalty account to the transaction, as illustrated in block 812.

Referring back to FIG. 8, the offers and/or loyalty accounts that a user 202 may accept are presented to the user 202 via his/her user device 204. As illustrated in 610, the user 202 may select to accept the offers and apply then to the current transaction or save the offers for a future transaction. As illustrated in 612, the user 202 may select to accept the loyalty accounts for the current transaction or save them for a future transaction. The user 202 may also decide to allow the system to automatically enroll him/her into the loyalty account or allow the user 202 to manually enroll himself/herself into the loyalty account.

Once the user 202 has selected the offers and/or loyalty accounts the offers and/or loyalty accounts may be applied to the transaction, as illustrated in block 812. The user 202 may then receive a total cost for the transaction and provide a payment account for payment for the transaction, as illustrated in block 814. Once the payment has been tendered by the user 202, the transaction may be completed, as illustrated in block 816.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing expedited processing at a point-of-transaction, the system comprising:
a memory device with computer-readable program code stored thereon;
a communication device;
a processing device operatively coupled to the memory device and the communication device, wherein the processing device is configured to execute the computer-readable program code to:
receive an indication that a user is initiating a transaction at a merchant point-of-transaction;
receive data associated with the initiation of the transaction;
match the data associated with the initiation of the transaction with data stored on a database to determine offers that the user is likely to use, wherein the database comprises available offers associated with the merchant;
determine offers available to the user based at least in part on the matching of the data associated with the initiation of the transaction and the data stored on the database;
present, dynamically, the offers available to the user;
receive indication of user selected offers; and
communicate the user selected offers to the merchant such that the offers are applied to the transaction.

2. The system of claim 1, wherein presenting, dynamically, the offers available to the user comprising providing a detectable indicia at the point-of-transaction wherein the detectable indicia can be captured by the user via a mobile device, wherein the detectable indicia further comprises the offers available to the user.

3. The system of claim 2, wherein the detectable indicia changes form based on the offers available to the user.

4. The system of claim 1, wherein the indication that the user is initiating a transaction at a merchant point-of-transaction includes receiving an indication that the user captured a pre-presented indicia.

5. The system of claim 1, wherein the data associated with the initiation of the transaction include one or more of products of the transaction, user identification information, or merchant information associated with the transaction.

6. The system of claim 1, wherein the database further comprises information about the user relating to one or more of user personal data, previously transacted for products, previously transacted for types of products, or previously accepted offers from one or more of the merchant of the transaction or a financial institution associated with the user.

7. The system of claim 1, wherein offers further comprise promotions, discounts, or coupons for the products of the transaction.

8. The system of claim 1, wherein offers further comprise loyalty accounts for the merchant of the transaction or a manufacturer of the products of the transaction.

9. The system of claim 1, wherein information from the database is used to automatically enroll the user in the loyalty accounts selected by the user, such that the loyalty account is applied to the transaction.

10. A computer program product for providing expedited processing at a point-of-transaction, the computer program product comprising at least one non-transitory computer-readable medium having computer-readable program code portions embodied therein, the computer-readable program code portions comprising:
an executable portion configured for receiving an indication that a user is initiating a transaction at a merchant point-of-transaction;
an executable portion configured for receiving data associated with the initiation of the transaction;
an executable portion configured for matching the data associated with the initiation of the transaction with data stored on a database to determine offers that the user is likely to use, wherein the database comprises available offers associated with the merchant;
an executable portion configured for determining offers available to the user based at least in part on the matching of the data associated with the initiation of the transaction and the data stored on the database;
an executable portion configured for presenting, dynamically, the offers available to the user;
an executable portion configured for receiving indication of user selected offers; and
an executable portion configured for communicating the user selected offers to the merchant such that the offers are applied to the transaction.

11. The computer program product of claim 10, wherein presenting, dynamically, the offers available to the user comprising providing a detectable indicia at the point-of-transaction wherein the detectable indicia can be captured by the user via a mobile device, wherein the detectable indicia further comprises the offers available to the user.

12. The computer program product of claim 11, wherein the detectable indicia changes form based on the offers available to the user.

13. The computer program product of claim 10, wherein the indication that the user is initiating a transaction at a merchant point-of-transaction includes receiving an indication that the user captured a pre-presented indicia.

14. The computer program product of claim 10, wherein the data associated with the initiation of the transaction include one or more of products of the transaction, user identification information, or merchant information associated with the transaction.

15. The computer program product of claim 10, wherein the database further comprises information about the user relating to one or more of user personal data, previously transacted for products, previously transacted for types of products, or previously accepted offers from one or more of the merchant of the transaction or a financial institution associated with the user.

16. The computer program product of claim 10, wherein offers further comprise promotions, discounts, or coupons for the products of the transaction.

17. The computer program product of claim 10, wherein offers further comprise loyalty accounts for the merchant of the transaction or a manufacturer of the products of the transaction.

18. The computer program product of claim 10, wherein information from the database is used to automatically enroll the user in the loyalty accounts selected by the user, such that the loyalty account is applied to the transaction.

19. A computer-implemented method for providing expedited processing at a point-of-transaction, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving an indication that a user is initiating a transaction at a merchant point-of-transaction;
receiving data associated with the initiation of the transaction;
matching, via the computer processing device, the data associated with the initiation of the transaction with data stored on a database to determine offers that the user is likely to use, wherein the database comprises available offers associated with the merchant;
determining offers available to the user based at least in part on the matching of the data associated with the initiation of the transaction and the data stored on the database;
presenting, dynamically, the offers available to the user;
receiving indication of user selected offers; and
communicating the user selected offers to the merchant such that the offers are applied to the transaction.

20. The method of claim 19, wherein presenting, dynamically, the offers available to the user comprising providing a detectable indicia at the point-of-transaction wherein the detectable indicia can be captured by the user via a mobile device, wherein the detectable indicia further comprises the offers available to the user.

21. The method of claim 20, wherein the detectable indicia changes form based on the offers available to the user.

22. The method of claim 19, wherein the indication that the user is initiating a transaction at a merchant point-of-transaction includes receiving an indication that the user captured a pre-presented indicia.

23. The method of claim 19, wherein the data associated with the initiation of the transaction include one or more of products of the transaction, user identification information, or merchant information associated with the transaction.

24. The method of claim 19, wherein the database further comprises information about the user relating to one or more of user personal data, previously transacted for products, previously transacted for types of products, or previously accepted offers from one or more of the merchant of the transaction or a financial institution associated with the user.

25. The method of claim 19, wherein offers further comprise promotions, discounts, or coupons for the products of the transaction.

26. The method of claim 19, wherein offers further comprise loyalty accounts for the merchant of the transaction or a manufacturer of the products of the transaction.

27. The method of claim 19, wherein information from the database is used to automatically enroll the user in the loyalty accounts selected by the user, such that the loyalty account is applied to the transaction.
